(19) United States
(12) Patent Application Publication
(10) Pub. No.: US 2004/0219847 A1
(43) Pub. Date: Nov. 4, 2004

(54) Method for flexibilizing glass fiber nonwoven bound with cured urea formaldehyde resin

(76) Inventor: Wayne P. Miller, St. Paul, MN (US)

Correspondence Address: Kirsten K. Stone, H.B. Fuller Company, Patent Department, 1200 Willow Lake Blvd., P.O. Box 64683, St. Paul, MN, 55164-0683, US

(21) Appl. No.: 10/427,241

(22) Filed: Apr. 30, 2003

(51) Int. Cl. B32B 17/02; B32B 5/02; B32B 27/04

(52) U.S. Cl. 442/104; 442/180; 427/372.2; 427/389.7; 427/389.8

(57) ABSTRACT

A method for flexibilizing a glass fiber nonwoven bound with a cured urea formaldehyde resin binder by admixing water, a cured urea formaldehyde resin, and a water-soluble polymer comprising a polymerized ethylenically unsaturated carboxylic acid monomer, the polymer having a weight average molecular weight of from about 65,000 to about 95,000; applying the aqueous admixture to a glass fiber nonwoven; and heating the admixture to at least about 120° C. Also disclosed are glass fiber nonwovens made using the method.

### BACKGROUND OF THE INVENTION

This invention relates to a method for flexibilizing cured urea formaldehyde resin-bound glass fiber nonwovens. More particularly, this invention relates to a method for flexibilizing a glass fiber nonwoven bound with a cured urea formaldehyde resin binder by admixing with water and a urea formaldehyde resin, a low molecular weight, water-soluble polymer comprising a polymerized ethylenically unsaturated carboxylic acid monomer; applying the aqueous admixture to a glass fiber nonwoven; and heating the admixture to at least about 120° C. The invention also relates to a glass fiber nonwoven made using the method of the invention.

U.S. Pat. No. 5,334,648 discloses acrylic, styrene-butadiene, and vinyl chloride copolymer latex modifiers for urea formaldehyde resins, the modifiers used at a level of about 10%, based on the weight of the urea formaldehyde resin, in order to improve the wet and dry strength of a polymer-bound glass fiber mat.

U.S. Pat. No. 5,804,254 discloses a method for flexibilizing a glass fiber nonwoven bound with a cured urea formaldehyde resin binder in which the binder includes a cured urea formaldehyde resin and 0.5-5% by weight, based on the weight of the urea formaldehyde resin, of a water-soluble polymer comprising 40-100% by weight of a polymerized ethylenically unsaturated carboxylic acid monomer, the polymer having a weight average molecular weight from 100,000 to 2,000,000.

While the above methods can be used to flexibilize a glass fiber nonwoven bound with a cured urea formaldehyde resin binder, there is a continuing need for improved methods that provide good strength while being easier to apply as an aqueous admixture onto a glass fiber nonwoven. “Flexibilizing” herein is typically indicated by increased wet and dry strength and/or improved tear strength, relative to a glass fiber nonwoven not containing the water-soluble polymer herein.

### BRIEF DESCRIPTION OF THE INVENTION

In one aspect of the present invention, there is provided a method for flexibilizing a glass fiber nonwoven bound with a cured urea formaldehyde resin binder comprising:

(a) admixing with water and a urea formaldehyde resin, from about 0.5% to about 10% by weight, based on the weight of the urea formaldehyde resin, of a water-soluble polymer comprising from about 40% to about 100% by weight, based on polymer weight, of a polymerized ethylenically unsaturated carboxylic acid monomer, said polymer having a weight average molecular weight of from about 65,000 to about 95,000;

(b) applying the aqueous admixture of step a) to a glass fiber nonwoven; and

(c) heating the admixture to at least about 120° C.

In another aspect, the invention relates to a glass fiber nonwoven bound with a cured urea formaldehyde resin binder comprising from about 0.5% to about 10% by weight, based on the weight of the urea formaldehyde resin, of a water-soluble polymer comprising from about 40% to about 100% by weight, based on polymer weight, of a polymerized ethylenically unsaturated carboxylic acid monomer, said polymer having a weight average molecular weight of from about 65,000 to about 95,000.

The present invention provides a glass fiber nonwoven having good wet and dry tensile strength and tear strength. Moreover, aqueous admixtures comprising the water-soluble polymer herein typically have low viscosity and are non-foaming. Thus, the polymer can be used a higher levels (e.g., up to about 10% by weight, based on the weight of the urea formaldehyde resin) without causing overall high viscosity that makes it difficult to use and handle the composition on production equipment.

### DETAILED DESCRIPTION OF THE INVENTION

Urea formaldehyde resins are well known and widely commercially available. They are formed from the reaction of urea and formaldehyde to form compounds containing methylol groups, which subsequently under the application of heat, with or without catalysts, react further, or condense, or cure to form polymers. The methylol groups in the resin are known to react with active hydrogen groups such as other methylol groups to form ether or methylene groups thereby forming polymeric structures. Such polymeric structures are generally brittle and nowovens containing such resins as binders tend to be relatively inflexible. Examples of commercially available urea formaldehyde resins include Casco-Resin FG-487 and FG-515 (Borden, Inc.) and GP TM 2980 RESIMAT™ Glass Mat Binder Resin.

The water-soluble polymer comprises from about 40% to about 100%, preferably from about 60% to about 100%, by weight, based on polymer weight, of at least one polymerized ethylenically unsaturated carboxylic acid monomer. The water-soluble polymer is formed by the free radical addition polymerization of the ethylenically unsaturated monomers such as, for example, methacrylic acid, acrylic acid, crotonic acid, fumaric acid, maleic acid, 2-methyl maleic acid, itaconic acid, 2-methyl itaconic acid, a,b-methylene glutaric acid, and salts thereof. Alternatively, ethylenically unsaturated anhydrides that form carboxylic acids during or subsequent to polymerization may be used in the polymerization, such as, for example, maleic anhydride, itaconic anhydride, acrylic anhydride, and methacrylic anhydride.

Additional ethylenically unsaturated monomer(s) may be copolymerized with the carboxylic acid monomer in an amount of from 0% to about 60%, preferably from 0% to about 40%, by weight, based on polymer weight, such as, for example, acrylic ester monomers including methyl acrylate, ethyl acrylate, butyl acrylate, 2-ethylhexyl acrylate, decyl acrylate, methyl methacrylate, butyl methacrylate, isodecyl methacrylate, hydroxyethyl acrylate, hydroxyethyl methacrylate, and hydroxypropyl methacrylate; acrylamide or substituted acrylamides; styrene or substituted styrenes; butadiene; vinyl acetate or other vinyl esters; acrylonitrile or methacrylonitrile; and the like. The optional, additional ethylenically unsaturated monomer should be selected so as not to render the polymer insoluble in water. Thus, only lesser amounts of hydrophobic monomers may be used, while greater amounts of hydrophilic monomers may be used, without compromising water solubility of the polymer.

The water-soluble polymer preferably comprises a polymerized carboxylic acid monomer selected from the group consisting of methacrylic acid, acrylic acid, and mixtures thereof. In one embodiment, the water-soluble polymer comprises acrylic acid copolymerized with acrylamide, vinyl acetate, or methyl acrylate, or mixtures thereof.

The water-soluble polymer may be prepared by solution polymerization in an aqueous medium by techniques for polymerizing ethylenically-unsaturated monomers which are well known in the art. By “aqueous” herein is meant that the medium is predominantly composed of water, although water-miscible organic solvents may also be present. The polymerization may be carried out by various means such as, for example, with all of the monomer in the reaction kettle at the beginning of the polymerization reaction or with some or all of the monomer being added throughout the course of the reaction.

The polymerization reaction to prepare the addition polymer may be initiated by various methods known in the art such as, for example, by using the thermal decomposition of an initiator and by using an oxidation-reduction reaction (“redox reaction”) to generate free radicals to effect the polymerization.

The water-soluble polymer herein has a weight average molecular weight from about 65,000 to about 95,000, preferably from about 70,000 to about 90,000, more preferably from about 70,000 to about 85,000, as measured by aqueous gel permeation chromatography. Molecular weights lower than about 65,000 may not provide the strength improvements desired. Molecular weights higher than about 100,000 lead to a higher viscosity of the aqueous admixture at a desirable solids level than is preferred for conventional methods of application to the glass fiber nonwoven. Chain transfer agents such as mercaptans, polymercaptans, and halogen compounds may be used in the polymerization mixture in order to moderate the molecular weight of the water-soluble. Generally, from 0% to about 1% by weight, based on the weight of the polymeric binder, of C₄-C₂₀ alkyl mercaptans, mercaptopropionic acid, or esters of mercaptopropionic acid, may be used.

The, aqueous admixture may be prepared by admixing water, the urea formaldehyde resin, and from about 0.5% to about 10%, preferably from about 1% to about 7%, more preferably from about 1% to about 5%, by weight, based on the weight of the urea formaldehyde resin, of the water-soluble polymer using conventional mixing or stirring techniques to provide a homogeneous solution.

The aqueous admixture may contain, in addition, conventional adjuvants such as, for example, pigments, fillers, anti-migration aids, curing agents, neutralizers, coalescents, wetting agents, biocides, plasticizers, organosilanes, anti-foaming agents, colorants, waxes, and anti-oxidants. The aqueous admixture may also contain latex modifiers such as disclosed in U.S. Pat. No. 6,384,116 B1, incorporated herein by reference, to further flexibilize the glass fiber nonwovens herein.

The aqueous admixture may be applied to a glass fiber nonwoven by conventional techniques such as, for example, air or airless spraying, padding, saturating, roll coating, curtain coating, beater deposition, coagulation, and the like. The amount of aqueous admixture typically applied is from about 10% to about 35%, preferably from about 15% to about 25%, LOI (Loss On Ignition), as determined using the following method.

The glass fiber nonwoven may be prepared from fibers of various lengths that may have been previously subjected to various treatment or primer steps. The glass fiber nonwoven may be of various thicknesses as appropriate for the desired end use and may have been formed by wet laid or dry laid processes. The glass fiber nonwoven may contain heat-resistant fibers other than glass, i.e., fibers which are substantially unaffected by exposure to temperatures above about 120° C., such as, for example, aramid fibers, ceramic fibers, metal fibers, carbon fibers, polyimide fibers, certain polyester fibers, and rayon fibers. The nonwoven may also contain fibers that are not themselves heat resistant such as, for example, certain polyester fibers and nylon fibers, in so far as they do not adversely affect the performance of the nonwoven.

The aqueous admixture, after it is applied to a glass fiber nonwoven, is heated to effect drying and curing. The duration and temperature of heating will affect the rate of drying, processability, and handleability, and property development of the treated substrate. Heat treatment at about 120° C. to about 400° C. for a period of time between about 3 seconds to about 15 minutes may be carried out. Treatment at about 150° C. to about 200° C. is preferred. The drying and curing functions may be conducted in two or more distinct steps, if desired. For example, the composition may be first heated at a temperature and for a time sufficient to substantially dry but not to substantially cure the composition and then heated for a second time at a higher temperature and/or for a longer period of time to effect curing. Such a procedure, referred to as “B-staging”, may be used to provide binder-treated nonwoven, for example, in roll form, which may at a later stage be cured, with or without forming or molding into a particular configuration, concurrent with the curing process.

The glass fiber nonwovens may be used for applications such as, for example, insulation batts or rolls, as reinforcing mat for roofing or flooring applications, as glass mat based asphalt roofing shingles, as roving, as microglass-based substrate for printed circuit boards or battery separators, as filter stock, as tape stock, and as reinforcement scrim in cementitious and non-cementitious coatings for masonry.

### Test Methods

Determination of Weight Average Molecular Weight:

Weight average molecular weight is determined by aqueous gel permeation chromatography on polyacid samples using a polyacrylic acid standard. Samples that are not 100% polycarboxylic acid are hydrolyzed to polyacid at 180° C. for 60 hours in KOH/ethanol and the molecular weight determined on the resulting polyacid, followed by correction for the actual composition.

Determination of LOI (Loss On Ignition):

A three-inch diameter piece of dried/cured fiberglass mat is cut using a circular die. The sample is weighed in a ceramic crucible and then placed in a muffle furnace at a temperature of 600° C. for 20 minutes. The sample is removed and then reweighed. % LOI is calculated using the equation: % LOI=(weight before burning-weight after burning) times 100/weight before burning.

The following examples illustrate some embodiments of this invention, but should not be construed to be any sort of limitation on its scope.

### EXAMPLES

### Example 1

### Preparation of Aqueous Admixture of Urea Formaldehyde (UF) Resin (FG-515 Resin from Borden, Inc.) and Water-Soluble Polymer

Admixtures are prepared at 25% solids content by mixing the following components at ambient temperature, with the pH adjusted to about 6-8 before mixing. Quantities listed in Table 1 are in grams.

TABLE 1

| | % | | | | | | |
|---|---|---|---|---|---|---|---|
| Resin | Solids | A | B | C | D | E | F |
| FG-515 | 55 | 450 | 443.2 | 450 | 443.2 | 443.2 | 406.8 |
| Polymer 1 | 32 | 7.8 | 19.5 | — | — | — | 19.5 |
| Polymer 2 | 30 | — | — | 8.3 | — | — | — |
| Polymer 3 | 34 | — | — | — | 18.75 | — | — |
| Polymer 4 | 30 | — | — | — | — | 21.25 | — |
| Water | — | 542.2 | 537.3 | 541.7 | 538.1 | 535.6 | 532 |
| PD8168C2 | 48 | — | — | — | — | — | 41.7 |
| Latex | | | | | | | |

Polymer 1 is a polyacrylic polymer comprising about 98% by weight acrylic acid and about 2% by weight acrylamide having a weight average molecular weight of about 75,000

Polymer 2 is a polymer comprising about 34% acrylic acid, 33% acrylamide and 33% vinyl acetate, having a weight average molecular weight of about 67,500.

Polymer 3 is a polymer comprising about 49% acrylic acid, 49% vinyl acetate and 2% hydroxyethyl acrylate, having a weight average molecular weight of about 71,000.

Polymer 4 is a polymer comprising about 60% methyl acrylate and 40% acrylic acid, having a weight average molecular weight of about 74,000.

PD8168C2 is an acrylic latex with a Tg of 85° C.

### Example 2

### Preparation of Polymer-Bound Glass Fiber Nonwovens

Glass fiber nonwoven handsheets are prepared with Owens Corning Fiberglas, Inc. OCF 9501 1 inch (about 2.5 cm) length glass chop using approximately 6.25 grams of glass fiber per sheet. The glass fiber is dispersed in water using about 500 ml of a 0.25% solution of SuperFloc A130 (from Cytec) and about 0.5 ml Rhodameen VP-532 (from Rhodia, Inc.). Handsheets are formed in a Williams handsheet mold. The wet sheets are transferred to a vacuum station and dewatered. The aqueous admixtures of Example 1 are applied, and excess is vacuumed off. The sheets are dried/cured in a forced air oven at 200° C. for 3 minutes. The binder amount on the sheets is about 24% LOI.

The above glass fiber nonwoven sheets exhibit wet and dry tensile strength and tear strength superior to that obtained using the UF resin alone.

Various embodiments of this invention have been described. However, this disclosure should not be deemed to be a limitation on the scope of the invention. Accordingly, various modifications, adaptations, and alternatives may occur to one skilled in the art without departing from the spirit and scope of the claimed invention.

What is claimed is:

1. A method for flexibilizing a glass fiber nonwoven bound with a cured urea formaldehyde resin binder, comprising:
a) admixing with water and a urea formaldehyde resin, from about 0.5% to about 10% by weight, based on the weight of the urea formaldehyde resin, of a water-soluble polymer comprising from about 40% to about 100% by weight, based on polymer weight, of a polymerized ethylenically unsaturated carboxylic acid monomer, said polymer having a weight average molecular weight of from about 65,000 to about 95,000;
b) applying the aqueous admixture of step a) to a glass fiber nonwoven; and
c) heating the admixture to at least about 120° C.

2. The method of claim 1 wherein the water-soluble polymer comprises a polymerized carboxylic acid monomer selected from the group consisting of methacrylic acid, acrylic acid, and mixtures thereof.

3. The method of claim 2 wherein the water-soluble polymer comprises acrylic acid copolymerized with acrylamide, vinyl acetate, or methyl acrylate, or mixtures thereof.

4. The method of claim 2 wherein the water-soluble polymer has a weight average molecular weight of from about 70,000 to about 90,000.

5. The method of claim 4 wherein the water-soluble polymer has a weight average molecular weight of from about 70,000 to about 85,000.

6. The method of claim 5 comprising admixing from about 1% to about 5% by weight of the water-soluble polymer in step a).

7. The method of claim 1 wherein the water-soluble polymer has a weight average molecular weight of from about 70,00 to about 90,000.

8. The method of claim 7 comprising admixing from about 1% to about 5% by weight of the water-soluble polymer in step a).

9. The method of claim 1 wherein the amount of aqueous admixture applied to the glass fiber nonwoven is from about 10% to about 35% LOI.

10. The method of claim 6 wherein the amount of aqueous admixture applied to the glass fiber nonwoven is from about 15% to about 25% LOI.

11. A glass fiber nonwoven bound with a cured urea formaldehyde resin binder comprising from about 0.5% to about 10% by weight, based on the weight of the urea formaldehyde resin, of a water-soluble polymer comprising from about 40% to about 100% by weight, based on polymer weight, of a polymerized ethylenically unsaturated carboxylic acid monomer, said polymer having a weight average molecular weight of from about 65,000 to about 95,000.

12. The glass fiber nonwoven of claim 11 wherein the water-soluble polymer comprises a polymerized carboxylic acid monomer selected from the group consisting of methacrylic acid, acrylic acid, and mixtures thereof.

13. The glass fiber nonwoven of claim 12 wherein the water-soluble polymer comprises acrylic acid copolymerized with acrylamide, vinyl acetate, or methyl acrylate, or mixtures thereof.

14. The glass fiber nonwoven of claim 12 wherein the water-soluble polymer has a weight average molecular weight of from about 70,000 to about 90,000.

15. The glass fiber nonwoven of claim 14 wherein the water-soluble polymer has a weight average molecular weight of from about 70,000 to about 85,000.

16. The glass fiber nonwoven of claim 15 comprising from about 1% to about 5% by weight, based on the weight of the urea formaldehyde resin, of the water-soluble polymer.

17. The glass fiber nonwoven of claim 11 wherein the water-soluble polymer has a weight average molecular weight of from about 70,000 to about 90,000.

18. The glass fiber nonwoven of claim 17 comprising from about 1% to about 5% by weight, based on the weight of the urea formaldehyde resin, of the water-soluble polymer.

19. The glass fiber nonwoven of claim 11 wherein the urea formaldehyde resin binder is applied to the glass fiber nonwoven in the form of an aqueous admixture in an amount of from about 10% to about 35% LOI.

20. The glass fiber nonwoven of claim 16 wherein the urea formaldehyde resin binder is applied to the glass fiber nonwoven in the form of an aqueous admixture in an amount of from about 10% to about 35% LOI.
